(19) United States
(12) Patent Application Publication
(10) Pub. No.: US 2009/0098340 A1
(43) Pub. Date: Apr. 16, 2009

(54) METHOD FOR NON-DESTRUCTIVE PATTERNING OF PHOTONIC CRYSTALS EMPLOYED FOR SOLID-STATE LIGHT EXTRACTION

(75) Inventors: Luis M. Campos, Santa Barbara, CA (US); Craig J. Hawker, Santa Barbara, CA (US); Ines Meinel, Santa Barbara, CA (US)

Correspondence Address: GATES & COOPER LLP;HOWARD HUGHES CENTER, 6701 CENTER DRIVE WEST, SUITE 1050, LOS ANGELES, CA, 90045, US

(73) Assignee: THE REGENTS OF THE UNIVERSITY OF CALIFORNIA, Oakland, CA (US)

(21) Appl. No.: 12/250,354

(22) Filed: Oct. 13, 2008

Related U.S. Application Data
(60) Provisional application No. 60/979,759, filed on Oct. 12, 2007.

(51) Int. Cl. B29C 41/42; B32B 3/00

(52) U.S. Cl. 428/156; 264/334

(57) ABSTRACT

A method for patterning metal oxides or ceramics on surfaces, and more particularly, a method of forming photonic crystals. The patterning is done using a solution coating process and a polymer-based template made by nano-imprint lithography. The methodology to pattern a sol-gel can be used to make features without the undesired scum layer. Furthermore, the patterned photonic crystals were demonstrated to efficiently increase the light extraction efficiency of solid state devices based on GaN.

### CROSS REFERENCE TO RELATED APPLICATIONS

This application claims the benefit under 35 U.S.C. Section 119(e) of co-pending and commonly-assigned U.S. Provisional Patent Application Ser. No. 60/979,759, filed on Oct. 12, 2007, by Luis M. Campos, Craig J. Hawker, and Ines Meinel, entitled “METHOD FOR NON-DESTRUCTIVE PATTERNING OF PHOTONIC CRYSTALS EMPLOYED FOR SOLID-STATE LIGHT EXTRACTION,” attorney's docket number 30794.252-US-P1 (2008-054), which application is incorporated by reference herein.

This application is related to the following co-pending and commonly-assigned U.S. patent applications:

U.S. Utility application Ser. No. ______, filed on same date herewith, by Craig J. Hawker, Luis M. Campos and Ines Meinel, entitled “THIOL-ENE BASED POLY(ALKYLSILOXANE) MATERIALS,” attorney's docket number 30794.251-US-U1 (2008-055), which application claims the benefit under 35 U.S.C. Section 119(e) of co-pending and commonly-assigned U.S. Provisional Application Ser. No. 60/979,767, filed on Oct. 12, 2007, by Craig J. Hawker, Luis M. Campos and Ines Meinel, entitled “THIOL-ENE BASED POLY(ALKYLSILOXANE) MATERIALS,” attorney's docket number 30794.251-US-P1 (2008-055);

which applications are incorporated by reference herein.

### BACKGROUND OF THE INVENTION

1. Field of the Invention

This invention relates generally to patterning of metal oxides or ceramics on surfaces, and more particularly to the formation of photonic crystals.

2. Description of the Related Art

(Note: This application references a number of different patents, patent applications and publications as indicated throughout the specification by patent number, patent application publication number, or one or more superscripted reference numbers, e.g. ^{x}. A list of the publications identified by the superscripted reference numbers can be found below in the section entitled “References.” Each of these patents, patent application publications and publications is incorporated by reference herein.)

Solid state lighting devices, such as light emitting diodes (LEDs), are now a booming area of research due to their potential for generating light with minimal energy uptake. Since its introduction in the early 1990's, gallium nitride (GaN) has been extensively studied within several device architectures to improve the efficiency. An extension of the techniques employed to improve the efficiency is the use of photonic crystals on the GaN surface to extract the waveguided modes, thus minimizing their internal reflection at the air interface.¹⁻³ In order to maximize the effect of the photonic crystals, they must have a high refractive index, comparable to GaN. Thus, high refractive index metal oxides such as titania and zirconia, or low refractive index materials such as silica, are of particular interest due to the relative ease of processing the patternable sol-gel precursors⁴ on the solid-state materials.

Unconventional methods for nano-fabrication (i.e. molding, embossing, printing, self-assembly etc.) offer a low-cost alternative to conventional lithography and etching techniques, which often lead to substantial damage of the underlying optical active area and/or conductive layers and require the use of expensive and time consuming vacuum equipment (deposition, etching) and lithography tools (e.g. photolithography, scanning beam lithography).⁵ Nano-imprint lithography (NIL) uses a rigid mold for pressure-induced pattern transfer into a thermoplastic polymer film, which serves as an etch mask to transfer the pattern into an underlying substrate. In contrast to conventional photolithography, it is easily applicable to feature sizes down to 50 nanometers (nm). However, this technique still relies on hard molds, which tend to wear during thermal cycling and pressure and also require expensive reactive ion etching (RIE) or inductively coupled plasma (ICP) etch steps.

Both of these drawbacks can be avoided with soft-lithography: soft molds (or stamps) are durable and very cheap to make from a topologically patterned hard master, without damaging the master itself. In addition, by directly molding a liquid pre-polymer or other liquid precursor (e.g. sol-gel), subsequent etching is avoided in the pattern transfer.

Several alternative methods have been proposed for the patterning of sol-gel derived materials and photonic crystals, describe different lithography techniques, and/or avoid the use of conventional vacuum-deposition and etching tools.

With holographic lithography, a periodic variation of the refractive index can be generated within photosensitive materials to create one or two dimensional photonic crystals. The pattern generated in the photoresist can be transferred into an underlying substrate using the conventional methods described above. However, doing holographic lithography on each sample is time consuming and not viable for industry.

Approaches to directly pattern a sol-gel film, without the use of an additional resist and subsequent vacuum requiring processing, are by electron beam-writing (PCT Publication No. WO0217347A1) or by Ultra-violet (UV) exposure of a photoacid containing sol-gel through a photo mask (U.S. Pat. No. 6,808,867 B2). The sol-gel in exposed regions will be cross-linked, whereas non-crosslinked regions can be dissolved away. With the former approach, nano-scale feature sizes can be realized, but the writing process is a conventional e-beam process and inherently too slow and expensive for mass-production. The second approach is not really suitable for nano-scale features, even with the use of extremely expensive optical equipment.

Another method for patterning ceramic photonic crystals relying on electron-beam lithography is described by Shimada et al.:¹⁶ sol-gels are introduced into a mold fabricated by electron-beam lithography, the residual scum layer on top is etched away, the mold dissolved, and the resulting array of pillars is fired at high temperature.

U.S. Pat. No. 6,752,942 B2 describes a method of forming articles including wave guides via capillary micro-molding and micro-transfer molding. For example, in one embodiment, a mold with a contoured surface is brought in contact with the substrate, and then a drop of sol-gel fluid precursors is placed at the openings on the side and drawn into the depressions of the mold by capillary forces, where it cures until the mold can be removed. In another embodiment, the sol-gel is placed on the substrate first, and the mold is placed on top and brought in contact with the substrate under pressure (roughly 10 pounds per square inch, psi), displacing the fluid into the depressions of the mold. These techniques, also more broadly known as ‘soft lithography,’ have successfully been demonstrated for dimensions in the micrometer scale but have been shown to fail for smaller feature sizes and high aspect ratios. This is mainly due to the nature of the mold material, which typically is a polydimethylsiloxane-based elastomer of relatively low modulus in order to facilitate the removal of the mold without damaging the patterned material or the mold itself. In addition, swelling of the mold in a variety of solvents limits the life-time of the mold, which is not sufficient for industrial use yet. Another issue associated with this technique is that it is nearly impossible to completely de-wet the surface between the mold and the substrate, and a small residual scum layer of the molded material is likely to be present. Significant progress has been made recently by using perfluoropolyether-based mold materials, as described in PCT Publication No. WO05101466A2, but a commercially viable process for mass-production has not been established yet.

On the other hand, tools for NIL first described in U.S. Pat. No. 5,772,905 and a variety of nano-imprint resists have recently become commercially available. The patterning of nm size features on whole wafers, including the necessary alignment, has been demonstrated. For the fabrication of photonic crystals, NIL has been used analogously to the photolithography process described above. Typically, the imprinted resist serves as an etch mask to transfer the pattern into underlying dielectric layers or the substrate, and several processing steps subsequent to the imprinting are necessary (U.S. Patent Application Publication No. 2005/0150864 A1).

A method has been described in U.S. Patent Application Publication No. 2005/0186515 A1, entitled “Structured Materials and Methods,” which generally talks about using a template, permeating the template with a precursor dissolved in a delivery agent, and reacting the precursor to form a structured material. Typical delivery agents in this case are supercritical or near supercritical fluids, and the deposition of materials is carried out in a sealed reaction vessel at a typical pressure between 50 bar and 500 bar.

U.S. Patent Application Publication No. 2005/0126470 A1 relates to the formation of self-assembled photonic crystals consisting of colloidal particles, which are introduced into a template made by NIL. Whereas one possible application of the present invention includes the formation of a photonic crystal in a lattice templated by NIL, the present invention is not related to colloidal particles but demonstrates a general method for patterning metal-oxides on the nanometer scale.

Spin-on based titanium dioxide nano-structures have recently been fabricated in combination with holographic lithography.¹⁷ A significant drawback of the holographic techniques is the sinusoidal shape inherent to the interference pattern, which does not allow for high aspect ratios and leads to less sharply defined features.

While all of the above described methods have been demonstrated on a small scale, a method suitable and viable for industrial production is still needed. The method demonstrated by the present invention uses a stamp having a composition of inexpensive and commercially-available materials that can be easily cured (within minutes) and having tunable properties. The stamping of the sol-gels can also be achieved at the sub-100 nm regime without a scum layer. It is demonstrated that photonic crystals with a period of the order of 250 nm can enhance the light extraction properties from GaN devices.

With NIL, as used in the embodiments described herein, structures with dimensions down to a few nm as well as larger structures can be fabricated. NIL tools are commercially available. For example, consider the disclosure of U.S. Pat. No. 5,772,905 entitled “Nano-imprint Lithography,” issued Jun. 30, 1998, to S. Y. Chou, as well as other relevant patents: European Patent No. EP 1072954 A2, U.S. Patent Application Publication Nos. 2004/0007799 A1, 2005/0133954 A1, and 2005/0238967 A1, and PCT Publication No. WO 2005/101466 A2.

### SUMMARY OF THE INVENTION

The methodology of the present invention deals with a soft-lithography technique for the fabrication of sol-gel derived TiO₂ photonic crystals for improved light extraction, thereby taking the NIL approach one step further. The liquid TiO₂ precursor sol-gel is molded directly using an elastomeric soft stamp, based on thiol-ene curable polysiloxane, which is described in the cross-referenced application by the inventors of the present invention,⁶ and partially cured at low temperature until the pattern is transferred and the mold can be removed. The only subsequent processing necessary is calcination at a desired temperature suitable for the specific application, typically between 200° C. and 700° C. This nano-fabrication method is fast, cheap, can be scaled up, and does not require any vacuum deposition or additional etching. In addition, sol-gel chemistry is very versatile and can be easily adapted to a variety of different materials and applications (e.g. mixed and doped metal-oxides, incorporation of nano-particles).

Therefore, to overcome the limitations in the prior art described above, and to overcome other limitations that will become apparent upon reading and understanding the present specification, the present invention describes a method for patterning a substrate, comprising: depositing a sol-gel on a substrate; placing a patterned thiol-ene stamp on top of the sol-gel; applying pressure on top of the stamp; allowing the sol-gel to dry; and peeling the thiol-ene stamp from the substrate to reveal a patterned sol-gel on top of the substrate.

In addition, the patterned sol-gel on the substrate may be calcined, the pressure may be between 1 and 90 psi, the sol-gel may be titanium dioxide, and the sol-gel may be allowed to dry naturally or may be heated.

A device may be fabricated using the method of the present invention. For example, the patterned sol-gel may be a photonic crystal and the substrate may be a light emitting device. The patterned sol-gel may be an n-type material and the substrate may be a photovoltaic device.

### BRIEF DESCRIPTION OF THE DRAWINGS

Referring now to the drawings in which like reference numbers represent corresponding parts throughout:

FIG. 1 is a schematic showing the use of poly[(3-mercaptopropyl)methylsiloxane] (PMMS) along with a series of organic-based cross-linking materials.

FIGS. 2A-2C are schematics illustrating a process for making and patterning sol-gels, wherein FIG. 2A illustrates casting sol-gel onto a substrate, FIG. 2B illustrates curing the sol-gel at low temperature, and FIG. 2C illustrates peeling off the stamp to reveal a patterned substrate.

FIG. 3A is a Scanning Electron Microscope (SEM) image of the sol-gel cast TiO₂, showing “holes” patterned by using the thiol-ene stamp patterned with posts (shown in the SEM image of FIG. 3B).

FIGS. 4A and 4B are angular photoluminescence (PL) intensity profiles of an InGaN/GaN multiple quantum well structure, in regions above (FIG. 4A) and next to (FIG. 4B) the TiO₂ photonic crystal, wherein the schematic representations of FIGS. 4C and 4D illustrate the experimental setup for achieving the profiles of FIGS. 4A and 4B, respectively, and FIGS. 4A and 4B plot intensity of PL as a function of wavelength (nm) and angle θ (in degrees, deg., and illustrated in FIGS. 4C and 4D) of the photodetector with respect to the photonic crystal surface.

FIG. 5 is a cross section of the images in FIGS. 4A and 4B for a fixed wavelength λₒ=430 nm, plotting PL intensity as a function of angle θ (deg.) for the cross-section, above (ON PhC, FM) and next to (OFF PhC) the photonic crystal, wherein the extracted wave-guided modes are clearly seen for the light emitted above the photonic crystal (PhC).

FIG. 6A is an SEM image of the thiol-ene stamp having posts ca. 55 nm wide by 80 nm high, and FIG. 6B is an SEM image of the patterned substrate with TiO₂ “holes.”

FIG. 7 is a flowchart illustrating a method of the present invention.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

Overview

Photonic crystals have been suggested to increase the light extraction out of inorganic (see U.S. Pat. No. 5,955,749) or organic LEDs (see U.S. Pat. No. 6,630,684 B2), and high and low refractive index materials, e.g. titanium dioxide, zirconia or silica, play an important role in order to achieve periodic structures with high refractive index contrast. Efficient and inexpensive patterning methods with high reproducibility are important for mass-production of such devices. The most commonly used method in micro-electronics is photolithography, where a predetermined pattern is irradiated on a photoresist coated device. The process is followed by several steps, such as developing the resist and transfer of the pattern to the device by wet-/dry-etching (or alternatively, vacuum-deposition of metals or other materials onto the developed areas) and removal of the resist (lift off). In addition to the time- and cost extensive use of vacuum equipment, the necessary optical equipment becomes disproportionately expensive to achieve nanometer scale features; which is also the drawback of techniques such as x-ray and electron-beam lithography. More importantly, the use of ion-based or plasma etching, such as O₂, for cleaning or scum layer removal leads to damage of the optical active area underneath (e.g. InGaAs quantum well) and/or the underlying doped conductive layers.

The present invention relates generally to a simple method for non-destructive patterning of metal oxides or ceramics on surfaces, and more particularly to the formation of photonic crystals. The patterning is done using a solution coating process and a template made by NIL. The feature dimensions achieved can be scaled down to the sub-100 nm regime. The materials employed are capable of directly patterning metal oxides or ceramics on surfaces without the need for subsequent etching and without an underlying undesired scum layer, thus avoiding the destructive etching processes that are generally employed and can be detrimental to the performance of the devices.

Technical Description

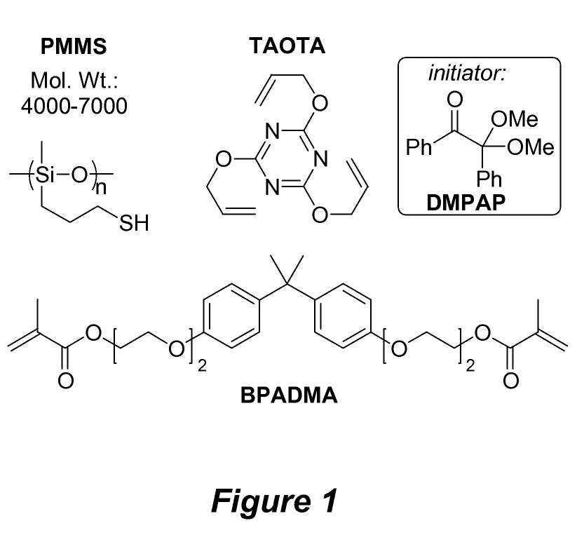

Soft lithography is among the most promising techniques for the patterning of nano- or micro-structures on surfaces. However, there are a limited number of reliable materials for soft lithography.⁷⁻¹⁴ The most widely used is an elastomer composed of a thermally crosslinked poly(dimethylsiloxane), PDMS, that is commercially available (Sylgard 184™, Dow-Corning). While this material leads to relatively facile patterning of micro-structures, the poor mechanical properties (Young's modulus, ca. 2 MPa)¹¹ lead to complications at dimensions below 1 μm. Gravity, adhesion, and capillary forces lead to collapse of features, if the aspect ratio is too high, or to sagging, if the aspect ratio is too low and the features are too widely separated.¹⁵ The stamp materials employed in the present invention are based on the thiol-ene cross-linking of poly([3-mercaptopropyl]methylsiloxane), PMMS, with 2,4,6-triallyloxy-1,3,5-triazine (TAOTA), ethoxylated (4) bisphenol A dimethacrylate (BPADMA), and less than 0.1 wt. % of the radical photoinitiator 2,2-dimethoxy-2-phenylacetophenone (DMPAP) (see FIG. 1). The resulting stamp has been fully characterized and described in the cross-referenced application by the inventors of the present invention.⁶ Herein, the material will be referred to as a “thiol-ene stamp,” in relation to the material composition described or any variable thereof.

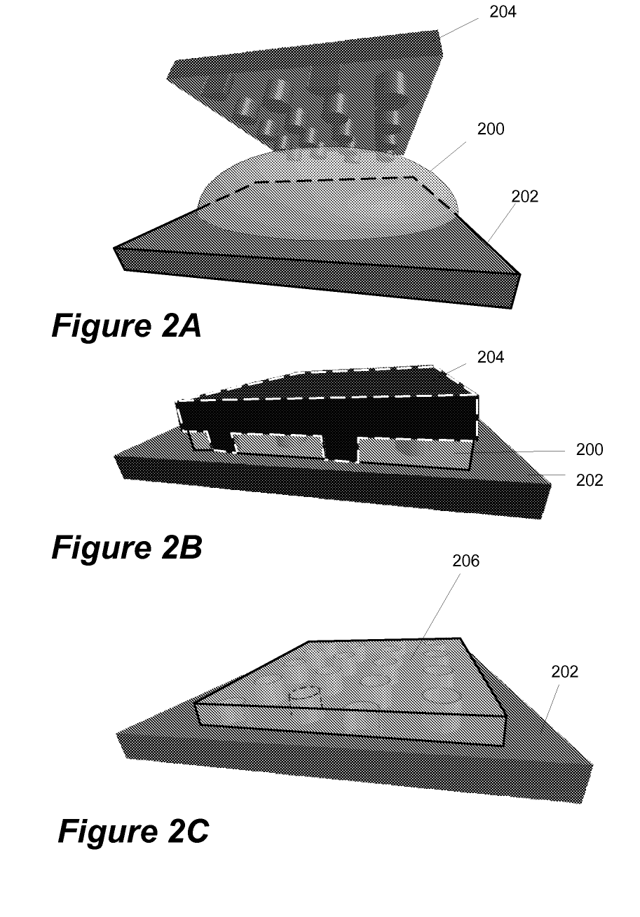

The process for patterning TiO₂ on silicon wafers is shown schematically in FIGS. 2A-2C. The TiO₂ sol-gel 200 was prepared and used fresh each time by mixing 0.4 mL (1.4 mmol) of Titanium(IV) isopropoxide with 0.08 mL (1.4 mmol) of acetic acid and stirring for 30 min in a capped vial charged with a stirring bar. Then, 0.08 mL of conc. HCl were added and the solution was allowed to stir. After 10 min., 1.4 mL of ethanol were then added, and the solution was stirred for an additional 30 min.

Then, ca. 10 μL of the sol-gel 200 were drop cast on the surface of the wafer 202 (FIG. 2A). As a more viable technique for industrial scales, ink jet printing, slot coating, or spin coating may be employed. Immediately after casting, a patterned thiol-ene stamp 204 (a square of ca. 1 cm² on average) was placed above the drop of sol-gel 200 (FIG. 2B). A small amount of pressure was applied on top, ranging from 1-90 psi. The sol-gel 200 was allowed to dry for ca. 16 hours (h) at room temperature in an open air environment. The slow evaporation at room temperature efficiently generated the solid titania pattern 206 when the sol-gel 200 was thoroughly dried.

Another technique involved the use of an automated press (such as a Nanonex Imprinter). In a step-wise fashion, under a pressure of 10 psi, the system was heated to: (a) 50° C. for 2 minutes; (b) 70° C. for 3 minutes; (c) 100° C. for 2 minutes; and finally (d) 120° C. for 3 minutes.

After peeling the stamps 204, the resulting patterned substrate was calcined at 400° C. for 2 minutes (at a heating and cooling rate of 10° C./min). This post-production treatment is optional and helps to increase the refractive index and the hardness of the titania. It was also noted that the resistance was minimal when peeling the stamps 204.

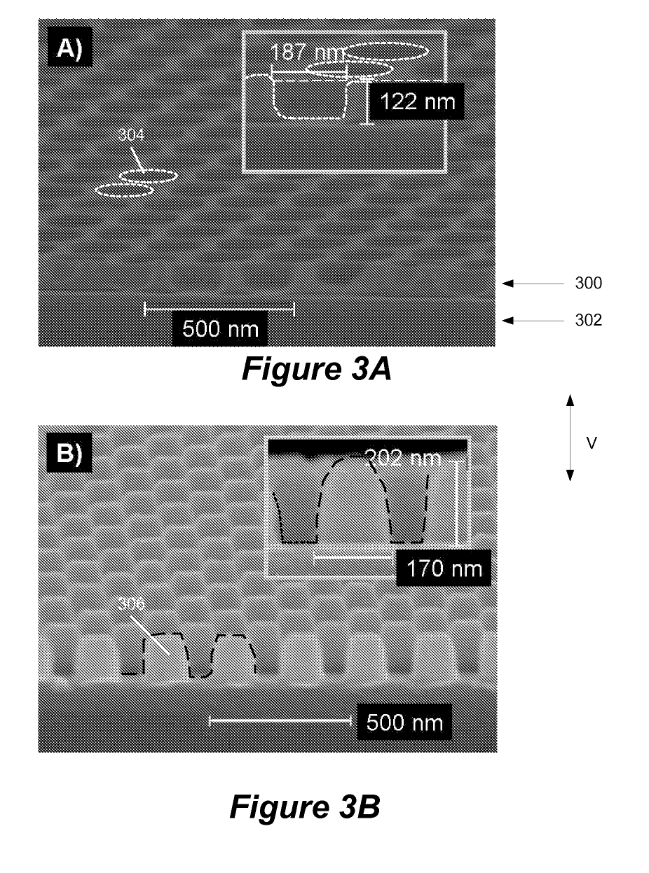

The resulting TiO₂ pattern 300 on a silicon wafer 302 (after postproduction calcination) is shown in FIG. 3A, and the thiol-ene stamp is shown in FIG. 3B. The resulting pattern shows that the holes 304 are larger then the original volume of the posts 306, as expected due to the solvent evaporation of the sol-gel. This is consistent with other publications which show that the shrinkage (˜50%) is largely anisotropic and primarily occurring in the vertical direction V, whereas the horizontal shrinkage is negligible due to good substrate adhesion.^{18,19}

The height of the posts 306 in the stamp was ca. 200 nm, and the resulting titania holes 304 are ca. 120 nm deep. Similarly, the posts 306 of diameter ca. 170 nm yielded holes 304 with a diameter ca. 190 nm. These measurements show that the difference between the diameter of the posts and the diameter of the resulting holes created by the posts was smaller than the difference between the height of the posts and the height of the resulting holes.

The patterns are satisfactorily replicated over large areas. Furthermore, one of the best characteristics of the pattern transfer was the absence of the scum layer, which is a residual TiO₂ layer at the bottom of the hole 304 that would prevent the exposure of the surface of the underlying substrate (in this case, the silicon wafer). Currently, many efforts are devoted to minimizing/eliminating scum layers using expensive perfluoropolyethers.²⁰

Having optimized the process of patterning titania sol-gels, the titania photonic crystals were then patterned onto GaN substrates with embedded InGaN quantum wells in order to measure the light extraction characteristics of the photonic crystals. In the measurement, the photoluminescence (PL) is measured with a detector scanning various angles with respect to the surface of the patterned substrate.

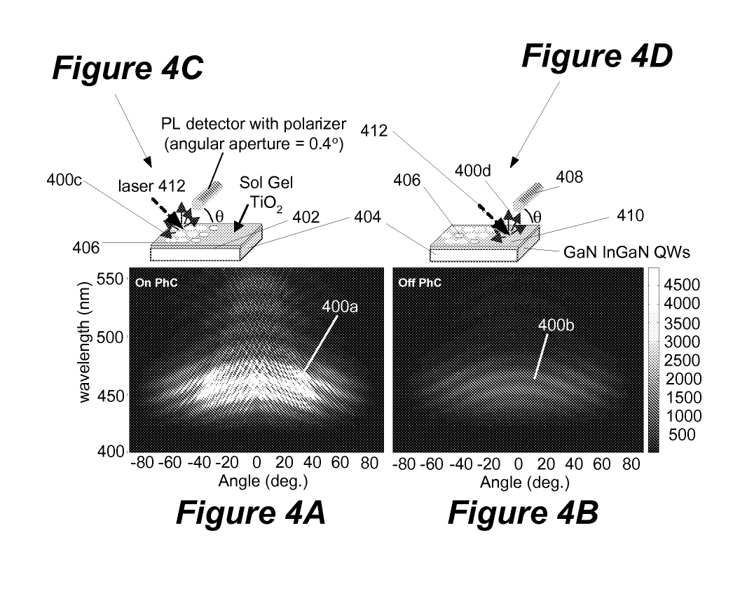

FIGS. 4A and 4B show the intensity 400a, 400b of the emitted light 400c, 400d from the surface 402 of an InGaN/GaN multiple quantum well structure 404 with (left, FIG. 4A) and without (right, FIG. 4B) the photonic crystal 406.

FIG. 4C is a schematic representation of the performed experiment leading to the results of FIG. 4A, illustrating a photonic crystal 406 (made from titania sol gel) on top of the multi quantum well structure 404, and a detector 408 positioned above the photonic crystal 406 to measure PL intensity 400a of light 400c from the GaN substrate (comprising GaN/InGaN quantum well structure 404) after interacting with the photonic crystal 406. FIG. 4D is a schematic representation of the performed experiment leading to the results of FIG. 4B, and shows the detector 408 positioned above a region 410 of the titania sol gel without a photonic crystal 406 (i.e. next to the photonic crystal 406), to measure PL intensity 400b of light 400d from the GaN substrate 404, which has not interacted with a photonic crystal 406. Laser light 412 was used to excite the quantum well 404. In FIGS. 4A-D, θ represents the angle at which PL 400a, 400b is measured, relative to the surface plane 402 of the quantum well structure 404.

From the low intensity of the light emitted 400b in FIG. 4B, it is clear that without the photonic crystal 406 almost all the light is trapped within the GaN substrate 404, as evidenced by the low intensity light emission 400b in FIG. 4B, whereas comparatively brighter light 400a is emitted above the photonic crystal 406, as evidenced in FIG. 4A.

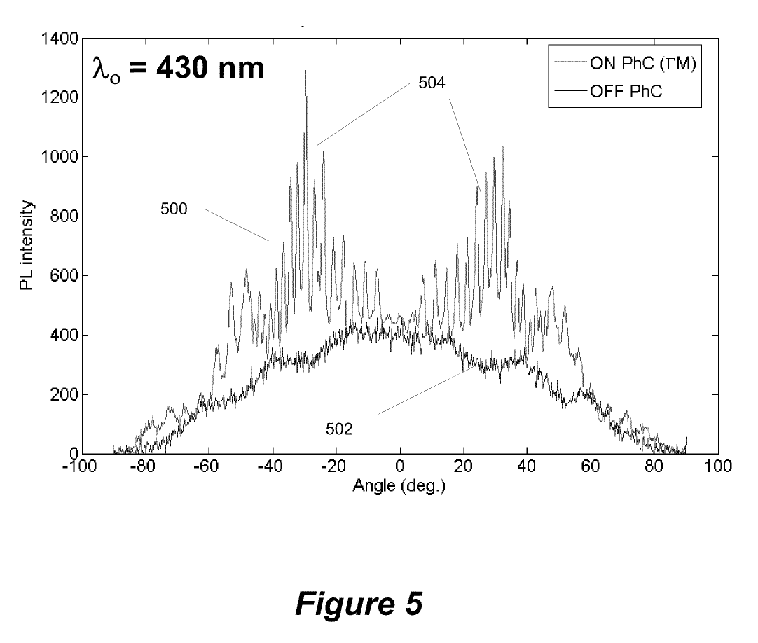

Furthermore, the extracted modes are clearly visible in the cross-section (FIG. 5). FIG. 5 is a cross section of the images in FIGS. 4A and 4B for a fixed wavelength of 430 nm. The data curve 500 shows a cross-section of angular PL 400a for light 400c emitted from a quantum well structure 404 with a photonic crystal 406 on top (i.e. for the schematic representation in FIG. 4C leading to the results of FIG. 4A, with the detector positioned above the photonic crystal, curve ON PhC). The data curve 502 shows a cross-section of angular PL 400b for light 400d emitted from a quantum well structure 404 without a photonic crystal 406 on top (i.e. for the schematic representation in FIG. 4D leading to the results of FIG. 4B, with the detector 408 positioned next to the photonic crystal 406, the curve OFF PhC). The extracted wave-guided modes 504 are clearly seen for the light 400c emitted above the photonic crystal 406.

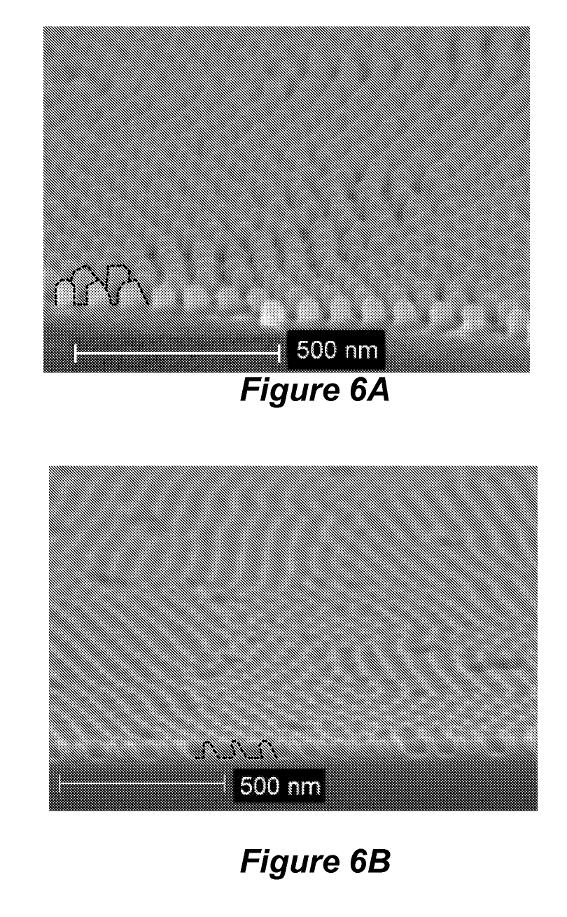

An extension to the patterning of titania at features below the 100-nm regime has proven to be a challenging process.^{21,22} Through the methodology described in FIG. 2 and using the stamp-making process from alumina templates described in the cross-referenced application by the inventors of the present invention,⁶ the patterning of sub-100 nm features has been accomplished. The SEM images of the stamp used and the resulting TiO₂ pattern are shown in FIG. 6A (FIG. 6A is an SEM image of the thiol-ene stamp having posts ca. 55 nm wide by 80 nm high, and FIG. 6B is an SEM image of the patterned substrate with TiO₂ “holes”). At this scale, the patterned substrate can not only be used as photonic crystals, but may be potentially employed as n-type materials in photovoltaics.²³

Process Steps

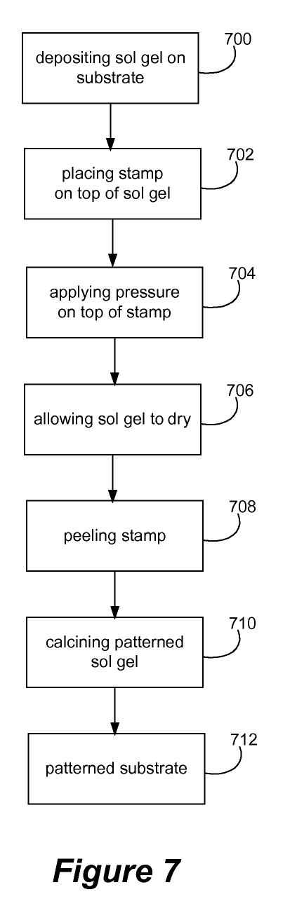

FIG. 7 is a flowchart illustrating a method for patterning a substrate.

Block 700 represents the step of depositing, for example, sol-gel, on a substrate. The sol-gel may be titanium dioxide, for example.

Block 702 represents the step of placing a patterned thiol-ene stamp on top of the sol-gel.

Block 704 represents the step of applying pressure on top of the stamp. The pressure may be between 1 and 90 psi, for example.

Block 706 represents the step of allowing the sol-gel to dry. The sol-gel may be allowed to dry naturally or may be heated, for example.

Block 708 represents the step of peeling the thiol-ene stamp from the substrate to reveal a patterned sol-gel on top of the substrate.

Block 710 represents the step of calcining the patterned sol gel.

Block 712 represents the device, or patterned substrate, fabricated by the method. The present invention is not limited to particular devices. For example, the present invention can be used wherever patterned coatings for devices are desirable. For example, the patterned sol-gel may be a photonic crystal and the substrate may be a light emitting device, wherein the photonic crystal increases light extraction from the light emitting device as compared to without the photonic crystal, for example. Or, the patterned sol-gel may be an n-type material and the substrate is a photovoltaic device.

### REFERENCES

The following references are incorporated by reference herein.
(1) Ichikawa, H.; Baba, T. Applied Physics Letters 2004, 84, 457-459.
(2) Aurelien, D.; Tetsuo, F.; Rajat, S.; Kelly, M.; Shuji, N.; Steven, P. D.; Evelyn, L. H.; Claude, W.; Henri, B. Applied Physics Letters 2006, 88, 061124.
(3) Diana, F. S.; David, A.; Meinel, I.; Sharma, R.; Weisbuch, C.; Nakamura, S.; Petroff, P. M. Nano Lett. 2006, 6, 1116-1120.
(4) Marzolin, C.; Smith, S. P.; Prentiss, M.; Whitesides, G. M. Advanced Materials 1998, 10, 571-574.
(5) Gates, B. D.; Xu, Q.; Stewart, M.; Ryan, D.; Willson, C. G.; Whitesides, G. M. Chem. Rev. 2005, 105, 1171-1196.
(6) U.S. Utility application Ser. No. ______, filed on same date herewith, by Craig J. Hawker, Luis M. Campos and Ines Meinel, entitled “THIOL-ENE BASED POLY(ALKYLSILOXANE) MATERIALS,” attorney's docket number 30794.251-US-U1 (2008-055), which application claims the benefit under 35 U.S.C. Section 119(e) of co-pending and commonly-assigned U.S. Provisional Application Ser. No. 60/979,767, filed on Oct. 12, 2007, by Craig J. Hawker, Luis M. Campos and Ines Meinel, entitled “THIOL-ENE BASED POLY(ALKYLSILOXANE) MATERIALS,” attorney's docket number 30794.251-US-P1 (2008-055).
(7) Hagberg, E. C.; Malkoch, M.; Ling, Y.; Hawker, C. J.; Carter, K. R. Nano Lett. 2007, 7, 233-237.
(8) Schmid, H.; Michel, B. Macromolecules 2000, 33, 3042-3049.
(9) Odom, T. W.; Love, J. C.; Wolfe, D. B.; Paul, K. E.; Whitesides, G. M. Langmuir 2002, 18, 5314-5320.
(10) Rolland, J. P. J. Am. Chem. Soc. 2004, 126, 2322-2323.
(11) Choi, K. M.; Rogers, J. A. J. Am. Chem. Soc. 2003, 125, 4060.
(12) Choi, S.; Yoo, P. J.; Baek, S. J.; Kim, T. W.; Lee, H. H. J. Am. Chem. Soc. 2004, 126, 7744-7745.
(13) Truong, T. T.; Lin, R.; Jeon, S.; Lee, H. H.; Maria, J.; Gaur, A.; Hua, F.; Meinel, I.; Rogers, J. A. Langmuir 2007.
(14) Truong, T. T.; Lin, R.; Jeon, S.; Lee, H. H.; Maria, J.; Gaur, A.; Hua, F.; Meinel, I.; Rogers, J. A. Langmuir 2007, 23, 2898-2905.
(15) Rogers, J. A.; Paul, K. E.; Whitesides, G. M. J. Vac. Sci. Technol. B 1998, 16, 88-97.
(16) Shimada, S.; Hirano, S.; Kuwabara, M. Jpn. J. Appl. Phys. 2003, 42, 6721-6725.
(17) Kim, S.-S.; Chun, C.; Hong, J.-C.; Kim, D.-Y. J. Mater. Chem. 2006, 16, 370-375.
(18) S. Seraji, Y. W. N. E. J.-L. M. J. F. S. J. L. T. P. C. G. C. Advanced Materials 2000, 12, 1421-1424.
(19) Li, M.; Tan, H.; Chen, L.; Wang, J.; Chou, S. Y. J. Vac. Sci. Technol. B 2003, 21, 660-663.
(20) Rolland, J. P.; Maynor, B. W.; Euliss, L. E.; Exner, A. E.; Denison, G. M.; DeSimone, J. M. J. Am. Chem. Soc. 2005, 127, 10096-10100.
(21) Li, H. W.; Muir, B. V. O.; Fichet, G.; Huck, W. T. S. Langmuir 2003, 19, 1963-1965.
(22) Goh, C.; Coakley, K. M.; McGehee, M. D. Nano Lett. 2005, 5, 1545-1549.
(23) Waldauf, C.; Morana, M.; Denk, P.; Schilinsky, P.; Coakley, K.; Choulis, S. A.; Brabec, C. J. Applied Physics Letters 2006, 89, 233517.

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for patterning a substrate, comprising:
(a) depositing a sol-gel on a substrate;
(b) placing a patterned thiol-ene stamp on top of the sol-gel;
(c) applying pressure on top of the stamp;
(d) allowing the sol-gel to dry; and
(e) peeling the thiol-ene stamp from the substrate to reveal a patterned sol-gel on top of the substrate.

2. The method of claim 1, wherein the patterned sol-gel on the substrate is calcined.

3. The method of claim 1, wherein the patterned sol-gel is a photonic crystal and the substrate is a light emitting device.

4. The method of claim 3, wherein the photonic crystal increases light extraction from the light emitting device as compared to without the photonic crystal.

5. The method of claim 1, wherein the patterned sol-gel is an n-type material and the substrate is a photovoltaic device.

6. The method of claim 1, wherein the pressure is between 1 and 90 psi.

7. The method of claim 1, wherein the sol-gel is titanium dioxide.

8. The method of claim 1, wherein the sol-gel is allowed to dry naturally or is heated.

9. A substrate patterned using the method of claim 1.
